(19) United States
(12) Patent Application Publication
(10) Pub. No.: US 2023/0284628 A1
(43) Pub. Date: Sep. 14, 2023

(54) COPPER FILTER WITH FAST VIRUS KILLING ABILITY

(71) Applicants: CITY UNIVERSITY OF HONG KONG, Kowloon (HK); CENTRE FOR IMMUNOLOGY & INFECTION LIMTED, Shatin (HK)

(72) Inventors: King-Ning TU, Kowloon (HK); Yingxia LIU, Kowloon (HK); Chang CHEN, Kowloon (HK); Lit Man POON, Shatin (HK); Wing Hong CHIN, Shatin (HK); Jin QU, Kowloon (HK); Yiyuan HENG, Kowloon (HK)

(21) Appl. No.: 18/182,237

(22) Filed: Mar. 10, 2023

Related U.S. Application Data
(60) Provisional application No. 63/319,165, filed on Mar. 11, 2022.
(60) Provisional application No. 63/327,340, filed on Apr. 4, 2022.
(60) Provisional application No. 63/388,988, filed on Jul. 13, 2022.
(60) Provisional application No. 63/427,588, filed on Nov. 23, 2022.
(60) Provisional application No. 63/429,790, filed on Dec. 2, 2022.

(51) Int. Cl. A01N 59/20; A01N 25/08; C25D 7/06; C25D 3/38; D06M 11/83

(52) U.S. Cl. CPC A01N 59/20; A01N 25/08; C25D 7/0607; C25D 3/38; D06M 11/83; D10B 2401/13

(57) ABSTRACT

A porous copper-based filter material that is electrodeposited with nanotwin copper to provide anti-pathogenic properties, particularly against Covid-19 or the SARS virus. The nanotwin copper is a thin layer of (111) oriented nanotwin copper microstructure.

### CROSS-REFERENCE TO RELATED APPLICATIONS

The present application claims priority to United States Provisional Application No. U.S. 63/319,165 filed with the United States Patent and Trademark Office on Mar. 11, 2022; United States Provisional Application No. U.S. 63/3274,340 filed with the United States Patent and Trademark Office on Apr. 4, 2022; United States Provisional Application No. U.S. 63/388,988 filed with the United States Patent and Trademark Office on Jul. 13, 2022; United States Provisional Application No. U.S. 63/427,588 filed with the United States Patent and Trademark Office on Nov. 23, 2022; and United States Provisional Application No. U.S. 63/429,790 filed with the United States Patent and Trademark Office on Dec. 2, 2022; all of which are incorporated herein by reference in their entirety for all purposes.

### FIELD OF INVENTION

The present invention relates to air filter materials useable in apparatuses including air-conditioner units, room ventilators and facemasks. In particular, the present invention relates to air filter materials that have virucidal properties.

### BACKGROUND OF THE INVENTION

The coronavirus COVID-19 is a serious worldwide public health problem which is caused by a severe acute respiratory syndrome coronavirus (SARS-CoV-2). The virus is highly mutatable and is likely to be an on-going re-emergent challenge. Thus, there is an urgent need to develop anti-pathogenic air filters capable of killing the virus.

Traditional air-conditioner filters use fiberglass or aluminium meshes that are only capable of capturing large particles such as lint and dust. Even high-efficiency particulate air (HEPA) filter cannot trap and kill viruses. In fact, a significant percentage of the viruses passes through HEPA filters and get re-circulated into ambient air.

It is well known that Cu (copper) and Cu-based surfaces exhibit excellent wide-spectrum virus inactivation capability. So far, however, the inactivation capability of Cu-based materials is not strong enough to kill all the viruses quickly through air flow.

Therefore, it is desirable to propose an improvement of Cu filters that could be used in often seen devices to mitigate the spread of viruses and pathogens.

### SUMMARY OF THE INVENTION

In a first aspect, the invention proposes an anti-pathogen filter, comprising a filter body having pores; wherein the surfaces of the filter body are coated with any one of (111) nanotwin Cu; Cu₆Sn₅ scallop; or (111) Cu nanosheet.

In one example, the surfaces of the filter body are coated with (111) nanotwin Cu or Cu₆Sn₅ scallop; and the filter body is a Cu structure. The Cu structure can be a Cu foam. Alternatively, the filter body is a cloth, the cloths being woven of fibre coated with Cu threads.

Optionally, the filter body is connected to a supply an electrical current to heat the filter such that the filter is at a temperature of 50 degrees C. to 200 degrees C.

In other examples, the filter body comprises cloth woven from fibre; and the surface of the fibre is adhered with (111) Cu nanosheet.

In a second aspect, the invention proposes a method of making an anti-pathogen filter comprising the step of: providing a filter body; coating the filter body with (111) nanotwin Cu; Cu₆Sn₅ scallop; or (111) Cu nanosheet.

Where the filter body is a Cu filter body, and the Cu filter body is coated with (111) nanotwin Cu; the method comprising the step of: providing the Cu filter body; electroplating the Cu filter body to coating the surface of the Cu filter body with nanotwin microstructure on the surface; wherein the electroplating step includes applying high current density under the following electroplating parameters:
Current density: 2 A/dm² (ampere per square decimeter, ASD) to 14 A/dm².
Stirring speed: 500-1200 rpm (magnet)!
Cathode: the Cu filter body;
Anode: pure Cu;

distance between cathode and anode: 1-8 cm.

Electroplating solution: high-purity of CuSO4 solution composed of 0.8 M Cu cations, KCl composed of 80 ppm chloride, 4000 ppm of surfactant, and 50 g/L-110 g/L of H₂SO₄.

Where the filter body is a Cu filter body, and the Cu filter body is coated with Cu₆Sn₅ scallop; the method comprising the steps of: immersing the Cu filter body into Sn liquid for a few seconds; removing the Cu filter body from the Sn liquid; and applying an etchant at 80 degrees Celsius to etch unreacted Sn on the surface of the Cu filter body, the etchant being 1 part nitric acid, 1 part acetic acid, and 4 parts glycerol. Where the filter body comprises cloth woven from fibre; and the surface of the fibre is adhered with (111) Cu nanosheet, the method comprising the steps of: dissolving into deionised water Cu chloride dihydrate, hexadecylamine and glucose to make a solution; adding iodine (12, 99.8+%) into the solution; mixing the solution at a temperature of 50˜150° C. to let the content in the solution react; extracting precipitated <111> single crystals of Cu of the reaction using chloroform; washing the precipitate with chloroform; washing the precipitate with water; providing fibre coated with adhesive; coating the adhesive with the <111> single crystals of Cu; spinning the fibre coated with <111> single crystals of Cu into threads and weaving the threads to produce the cloth. Preferably, the solution comprises: Cu chloride dihydrate (CuCl₂·₂H₂O, 99+%) at 0.5 to 15 g/L; hexadecylamine (98%) at 50 to 120 g/L; and glucose (99.5+%) at 10˜30 g/L. Typically, the method further comprises the steps of: applying an adhesive to coat fibres; mixing the adhesive-coated fibres with the <111> single crystals of Cu; spinning the fibres of the anti-pathogen material into threads.

Where the filter body is a Cu filter body, and the Cu filter body is coated with (111) nanotwin Cu or Cu₆Sn₅ scallop; the method comprising earlier steps of: providing pieces of cloths woven of Cu threads; annealing each piece of cloth under a slight compression to provide the cloth with a flat surface; stacking the pieces of the cloth to form a 3-dimensional structure; wherein the holes of every adjacent layer of metal cloth is eccentrically displaced at 45 degrees; and the distance of displacement is the width of the metal wires used to weave the cloth.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 is an SEM (Scanning Electron Microscope) image of the grid of a cloth woven of Cu threads;

FIG. 2 is an enlarged image of the cloth of FIG. 1;

FIG. 3, FIG. 4, FIG. 5 and FIG. 6 show different ways of aligning four pieces of the cloth of FIG. 1;

FIG. 7 illustrates the shared boundary that defines a nanotwin crystal;

FIG. 8 illustrates a nanotwin crystal in perspective;

FIG. 9a illustrates different orientations of a crystal, the right-most being in the (111) configuration;

FIG. 9b illustrates the process of preparing a filter body to be coated with nanotwin Cu;

FIG. 10a shows cones of nanotwin Cu that are deposited on surfaces of filter bodies;

FIG. 10b shows images of woven Cu threads before and after being electroplated with nanotwin Cu;

FIG. 11 shows the roll structure of a Cu filter that can be coated with nanotwin Cu;

FIG. 12 is a picture of Cu foams that can be coated with nanotwin Cu;

FIG. 13 is a closed up picture of Cu foam similar to those shown in FIG. 11;

FIG. 14a is an SEM image of Cu₆Sn₅ scallop formation on the surface of copper;

FIG. 14b is another SEM image of Cu₆Sn₅ scallops on a copper surface;

FIG. 14c and FIG. 14d are SEM images of Cu₆Sn₅ scallops on the Cu threads of a Cu cloth;

FIG. 14e is an SEM image of nanotwin cones on the electroporated surface and the cross-section of (111) nanotwin structure;

FIG. 15a is an SEM image of synthesized Cu nanosheet;

FIG. 15b shows Cu nanosheet of FIG. 15a sprinkled onto the glue-coated fibre;

FIG. 16 is a picture of a 3D-printed Cu structure that can be used as a filter in yet another embodiment of the invention;

FIG. 17 is a chart plotting the inactivation effect of and on the SARS-Cov-2;

FIG. 18 shows the SARS-Cov-2 inactivation effect of Cu cloth with different pore sizes (150 μm vs. 63 μm);

FIG. 19 shows the H1N1 inactivation effect of nanotwin Cu and polished nanotwin Cu;

FIG. 20 shows the H1N1 inactivation effect of Cu foam and nanotwin Cu foam;

FIG. 21 shows the H1N1 inactivation effect of 3D printing Cu;

FIG. 22 shows the FIPV inactivation effect of nanotwin Cu and polished nanotwin Cu; and

FIG. 23 shows the H1N1 inactivation effect of Cu₆Sn₅, polished Cu₆Sn₅, CuO, and Cu2O.

### DETAILED DESCRIPTION OF SPECIFIC EMBODIMENTS

### First Embodiment

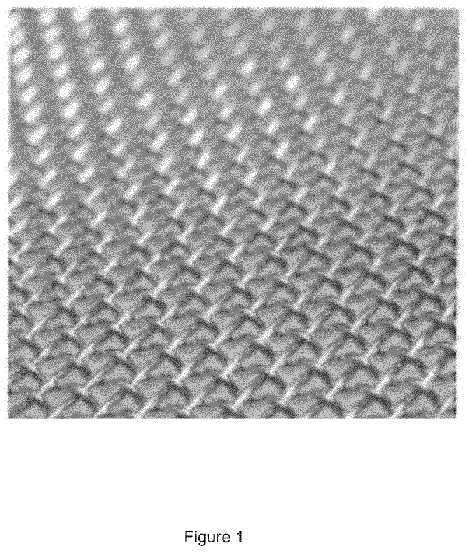

FIG. 1 shows a Scanning Electron Microscope (SEM) image of single layer of an anti-pathogenic filter, which is a piece of cloth woven of Cu (copper) threads. The Cu cloth is porous due to the spaces between the Cu threads. After being woven, the cloth is annealed at 400 degrees Celsius C for 30 minutes under slight compression, which provides the Cu cloth a flat surface.

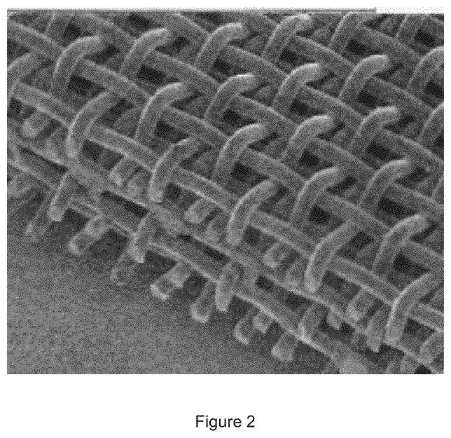

Subsequently, several pieces of such annealed cloth are stacked to form a 3-dimensional structure. FIG. 2 is another SEM image and shows such a porous Cu structure formed of 4 stacked layers of Cu cloth. This provides a filter body that is a Cu structure material, and which is porous and permeable to air. Preferably, every second layer is placed at a 45 degree offset in the diagonal direction from the first layer. That is, the second and the fourth layers are offset from the respective first and third layers by degrees. Also preferably, the offset distance is the width of a Cu thread.

In practice, as many layers as necessary may be stacked to form the filter body, but the thickness and malleability of a 4-layer stack is suitable for use as filter in most products.

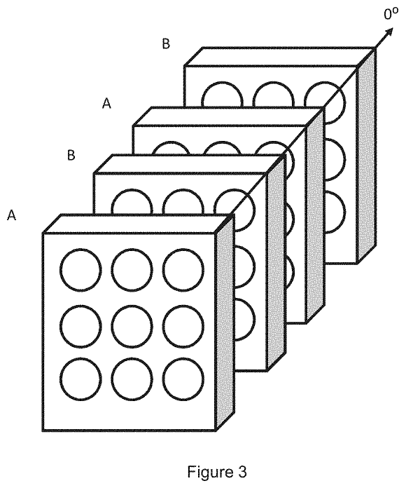

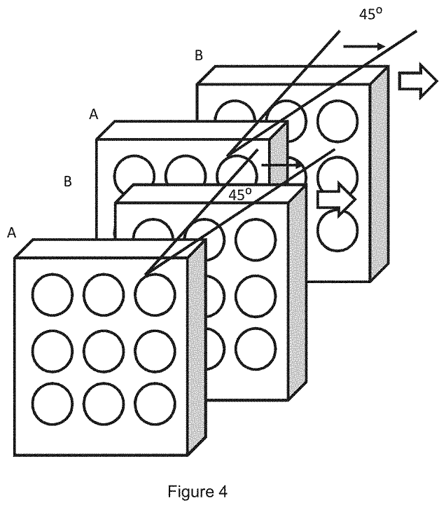

FIG. 3 illustrates two pieces of Cu cloth without displacement, for reference. FIG. 4 shows lateral displacement of all the second layers “B” with reference to the first layers “A”, FIG. 5 shows a vertical displacement of all the second layers “B” with reference to the first layers “A”, and FIG. 6 shows diagonal displacement of the second layers “B” with reference to the first layers “A”, at 45 degrees. All these 45 degree displacements in different directions may be a part of different embodiments, but the diagonal displacement is preferred.

The resultant structure has no through-path for airflow. Cu alone is able to kill airborne pathogens such as viruses on contact. However, in the embodiment, any micro-droplets containing virus in the air that is passing through the cloth eventually bumps into a Cu thread. The overall structure is lightweight, mechanically strong and has good heat and electrical conductivity.

Typically, the stack of Cu cloths are fixed to each other using solder paste applied at several locations on each piece of cloth, followed by rolling the stack. However, rolling is preferable but not necessary, depending on the size of the stack.

Subsequently, the entire stack is annealed under slight compression to induced inter-diffusion and reaction between the layers, thereby combining the layers into a strong 3-dimensional porous structure; the annealing overcomes any thin layer of copper oxide on the Cu surface which would have prevented the layers from merging.

In actual products, the permeability of the whole structure can be varied by stacking a different number of Cu cloths or using difference types of Cu cloth with different thickness and different pore density. As the skilled reader would appreciate, the size of the pores can also be determined by the density of the weaving.

In a variation of the embodiment, the layers are arranged without misalignment of the pores. That is, the cloths are mutually aligned by their pores. The 3-dimensional structure produced in this case has an array of through-holes, and is therefore more porous than the afore-mentioned structure with intentionally mis-aligned holes.

After the layers of Cu cloth have been stacked, a layer of oriented (111) nanotwin Cu is electro-deposited on the stacked structure.

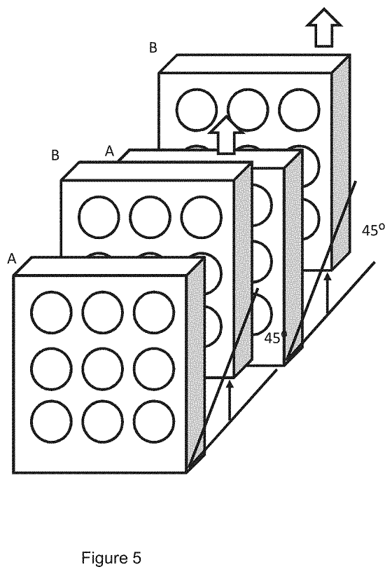

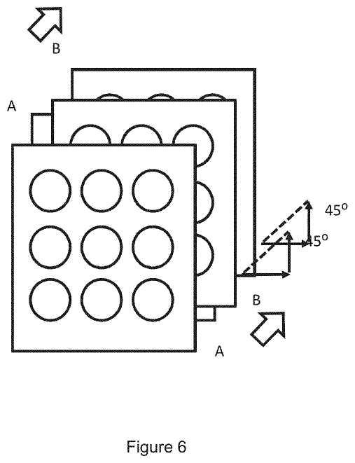

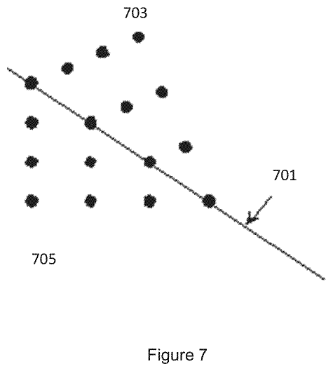

“Nanotwin” refers to a specific type of atomic arrangement where the tiny boundaries in the crystal structure are arranged symmetrically. This provides lattice points in one crystal which are with another crystal. FIG. 7 shows an example of such a shared boundary 701 between two crystal structures 703, 705 of the same material, dividing the structures into a symmetrical arrangement. FIG. 8 shows a three dimensional illustration of a crystal having a planar surface separating 2 individual crystals surfaces. The skilled reader would understand that there are many different twin structures, of which elaboration is not necessary here.

Nanotwin Cu has a high density of such boundary, which gives the crystals high strength, and high electrical conductivity that gives rise to high virucidal abilities. Furthermore, nanotwin coating provides a very rough and uneven surfaces on the microscopic level, which facilitate trapping of floating viruses. It is possible to rejuvenate the entire structure by re-electroplating after the structure has been in use for some time.

“111” refers to the orientation of the crystals as may be observed by crystallography.

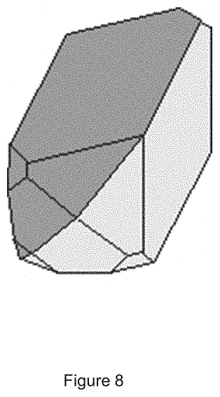

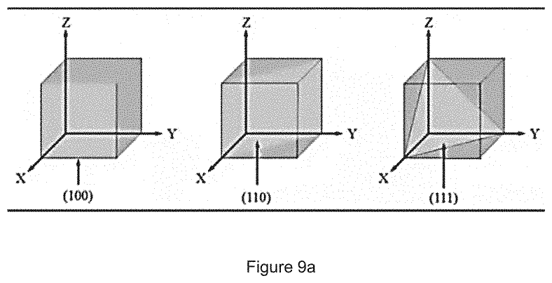

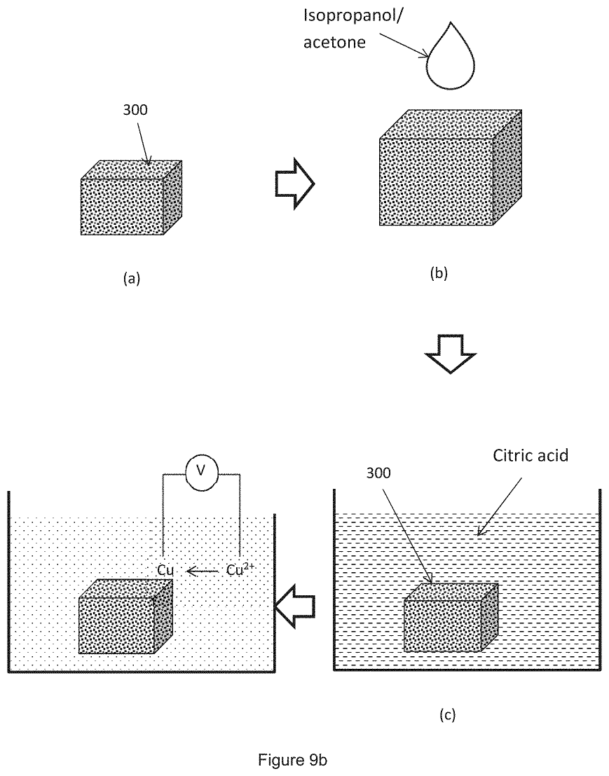

The (111) surface of the face-centered cubic metal has the highest number of dangling chemical bonds, which will facilitate charge transfer, as illustrated in the right-most drawing in FIG. 9a. The other two drawings in FIG. 9a show other kinds of crystal orientation, namely (100) and (110) which are not preferred orientations.

Accordingly, nanotwinned Cu coating the filter body of the present embodiment has the (111) plane as free surface, which enhances charge transfer to viruses in contact with the Cu. The mechanism of interaction between virus and Cu surfaces is still unclear, but it is believed that a trapped virus is attacked by charge transfer from Cu ions and atoms, causing the virus capsid to be broken, killing the virus effectively. Besides being virucidal, the material is also highly bactericidal.

Additionally, a (111) surface provides a much longer lifetime for Cu adatoms on the (111) surface.

FIG. 9b shows the steps of electroplating (111) nanotwin Cu onto microstructure filter body. The method comprises providing a 3-dimensional Cu structure at step (a). Then, at step (b), washing the Cu structure with isopropyl alcohol and/or acetone to remove contaminations. At step (c), the Cu structure is immersed in citric acid solution to remove surface oxides. Finally, at step (d) the Cu structure is treating with electroplating technique to obtain the nanotwin microstructure on the surface. The electroplating step includes applying high current density using the following electroplating parameters shown below.
1. Current density: 2 A/dm² (ampere per square decimeter, ASD) to 14 A/dm².
2. Stirring speed: 500-1200 rpm (magnet).
3. Cathode: the cleaned Cu filter body, anode: pure Cu. Distance between cathode and anode: 1-8 cm.
4. Electroplating solution: high-purity of CuSO4 solution composed of 0.8 M Cu cations, KCl composed of 80 ppm chloride, 4000 ppm of surfactant (EDC-107A, Chemleader, Taiwan), and 50 g/L-110 g/L of H2504.

The above method is able to deposit high-density nanotwin Cu onto the surface of the filter body.

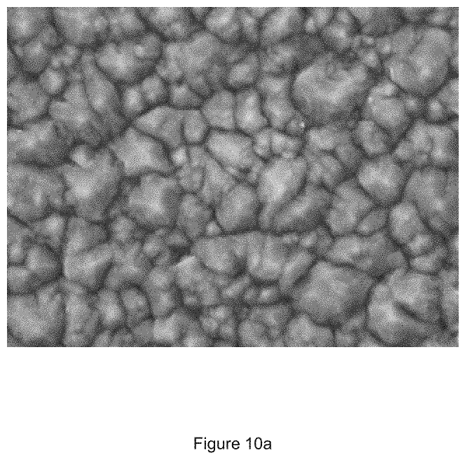

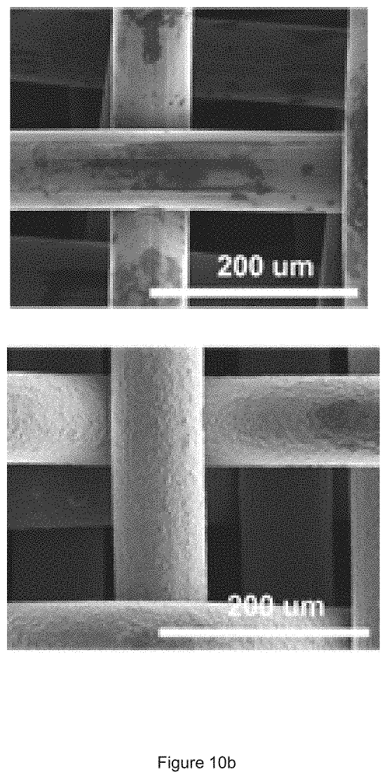

FIG. 10a is an SEM image of nanotwin Cu, which are in the shape of Cu cones. The shape is capable of trapping floating virus effectively.

FIG. 10b shows in the top an SEM image of woven Cu threads that has not been electroporated with nanotwin Cu, and in the bottom an SEM of woven Cu threads that has been electroporated with nanotwin Cu. It can be seen that the surface of the electroporated Cu threads are rougher.

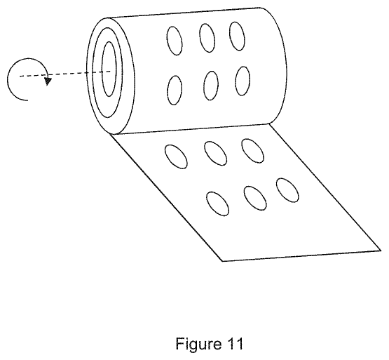

FIG. 11 shows a variation of the filter body in which, instead of a 3-dimensional structure of several layers of Cu cloths, a single layer of Cu cloth is rolled into a porous column, onto which is deposited nanotwin Cu using the method as described. In this case, the column is a circular filter, in which movement of air can pass from the centre of the roll to the external surface of the roll, or vice versa. However, the alignment of the different layers of pores formed from rolling the column is relatively random, unlike in the stacked version of FIG. 2.

### Second Embodiment

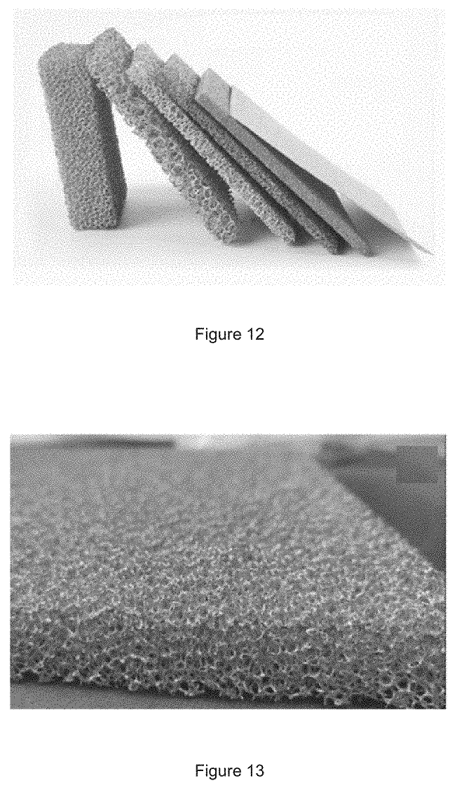

In a further embodiment, instead of a stack of woven Cu cloth, a solid foam made of Cu is used as the filter body. FIG. 12 is an optical image of a set of Cu foams. FIG. 13 is a closer image of one of the foams, showing the pores more clearly. The internal high porosity (>95%) of the Cu foam provides greater surface area for virus to contact, but remains highly permeable to air.

In this embodiment, firstly, a piece of commercially produced copper (Cu) foam is purchased and treated by the same steps as illustrated for the embodiment of FIG. 9b. That is, the Cu foam is washed with isopropyl alcohol and acetone to remove contaminations. Preferably, the thickness of the solid matric forming the foam has a thickness of 0.1 mm to 50 mm, and the pore size of the foam is 100 um to 2500 um. Subsequently, the foam is immersed into a critic acid solution to remove surface oxides. After that, the Cu foam is annealed under a slight compression to generate a flat surface. The Cu foam is then treated with reverse electroplating technique to provide nanotwin microstructure on the surface, during which the on-time and reverse-time duration time for each cycle and the current density will be controlled, respectively.

During reverse-electroplating, high current density is used to get a high-density nanotwin Cu. Furthermore, a high stirring rate is used to encourage forming of nanotwin Cu films.

Subsequently, a specific electroplating solution is prepared, and the Cu foam is placed into the solution to obtain a thin layer of (111) oriented nanotwin Cu microstructure (pore size ˜100 um).

The electroplating process is periodically reversed, such as every 10 minutes, by switching the anode and cathode supply so that the current flows in the reverse direction. This encourages formation of tiny Cu crystals, and increases the chance of forming nanotwin Cu crystals in high density on the surface of the Cu foam.

Actually, without reverse electroplating, nanotwin copper can also be deposited, but a very flat surface is required to deposit nanotwin copper. The reverse electroplating, however, is an etching process that can modify the sample surface and provide flatness. The flatness of sample surface is one of the key parameters to verify the anti-virus performance.

A high stirring rate is used during the process so that the nanotwin Cu deposited has the preferred (111) orientation. For example, a stirring magnet is used to apply stirring rate of 1200 rpm.

The electroplating bath is high-purity CuSO₄ solution with 0.8 M Cu cations. Afterwards, the above nanotwin-deposited Cu foam is cleaned with acetone and Deionized (DI) water for 5 minutes under the strong ultrasonic process, respectively. And then, the sample is dried by blowing with pure nitrogen gas.

In a variation of this embodiment, besides Cu, metallic cloth of other metals, such as 3-dimensional porous structure of gold (Au) may be used as the filter body.

Preferably, the nanotwin-coated Cu foam is heated to a temperature of between 50 to 200 degrees Celsius during use for more virucidal effect.

### Embodiment 3

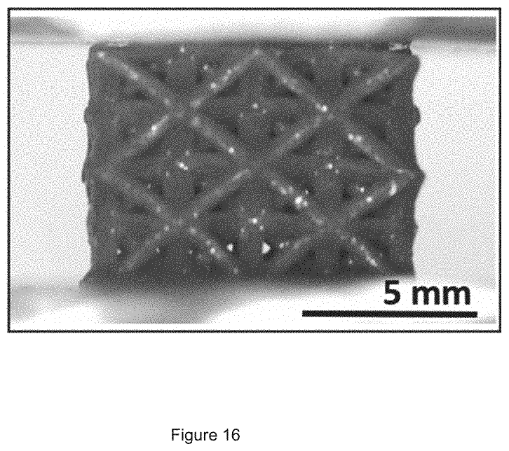

In another embodiment, instead of nanotwin Cu deposit, the surface of the Cu filter body (which can be stacked Cu cloth, Cu foam, or even a 3D printed Cu structure as shown in FIG. 16) is provided with a rough surface that is oxidation resistant, by growing Cu—Sn intermetallic compound on the filter body surface. In particular, scallops of Cu₆Sn₅ can be deposited into the surface.

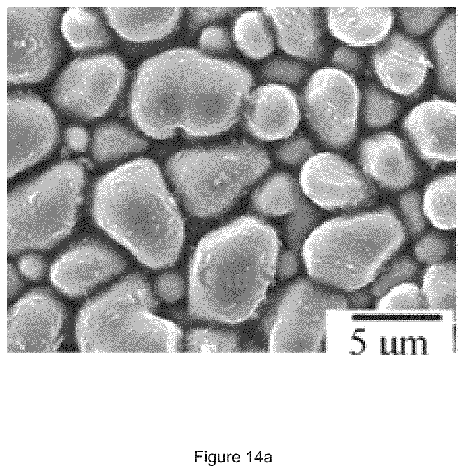

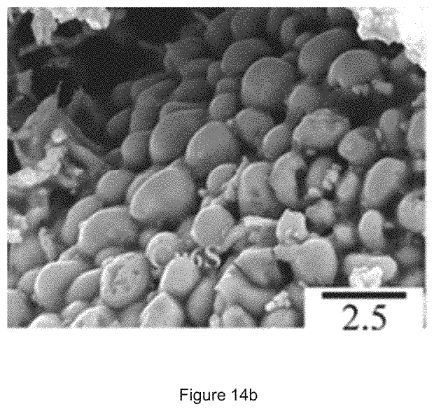

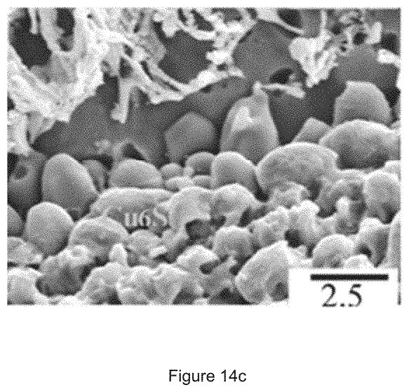

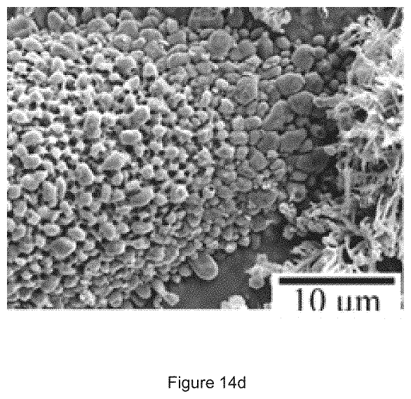

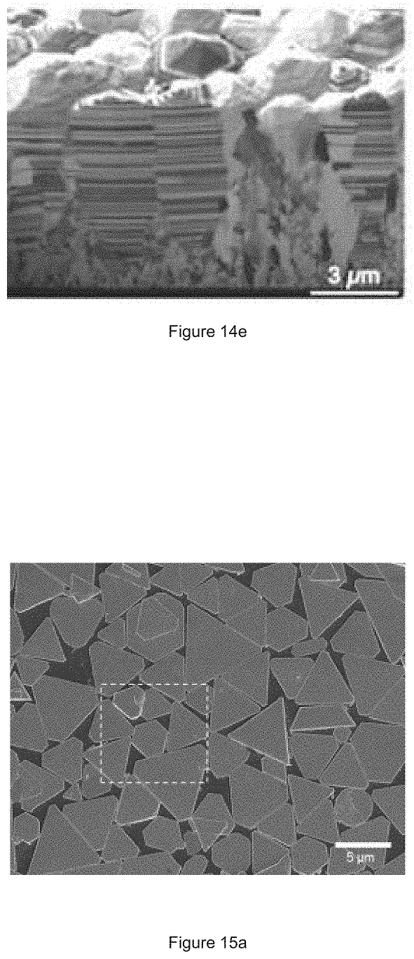

FIG. 14a is an SEM image of Cu₆Sn₅ scallop formation on a surface of copper. The scallop formation can be obtained by immersing a Cu filter body into liquid tin (Sn) for a few seconds. Subsequently, the filter body is taken out and the following acid solution is used to etch away the unreacted Sn. This produces on the surface Cu₆Sn₅ scallops.

FIG. 14b is another SEM image of Cu₆Sn₅ scallops on a copper surface. FIG. 14c and FIG. 14d are SEM images of Cu₆Sn₅ scallops on the Cu threads of a Cu cloth.

FIG. 14e is an SEM image of nanotwin cones on the electroporated surface and the cross-section of (111) nanotwin structure.

The surface of the scallops is very rough and is able to interact effectively with virus in the air. The scallop has the chemical composition of Cu₆Sn₅, so it is stable in air. While nanotwin Cu is very effective in killing virus rapidly, the advantage of Cu₆Sn₅ scallops shown here is improved stability in air which resists oxidation.

More specifically, FIG. 14a and FIG. 14b show scallops formed on a Cu wire kept at 260 degrees Celsius for 20 seconds and 2 minutes, respectively. This step is used to activate the superficial Cu wire to improve the generation of next step anti-oxidation layer of the solid phase of Cu₆Sn₅. As the skilled reader knows, however, different annealing time will affect the superficial Cu—Sn intermetallic compound, and the time may therefore be more than 2 minutes, particularly in a scaled-up plant.

Subsequently and optionally, Cu—SN intermetallic compounds (IMCs) coated filter body is put in an oven at 180° C. to age for 5 days, to obtain an anti-oxidation layer of the solid phase of Cu₆Sn₅. The Cu₆Sn₅ can protect the inner Cu wire from oxidization, and therefore exhibit an excellent anti-virus performance for a relatively long time.

Preferably, the etchant is 1 part nitric acid, 1 part acetic acid, and 4 parts glycerol at 80 degrees Celsius. A low-magnification image of scallops on a Cu wire in the Cu cloth is shown in FIG. 14d.

### Embodiment 4

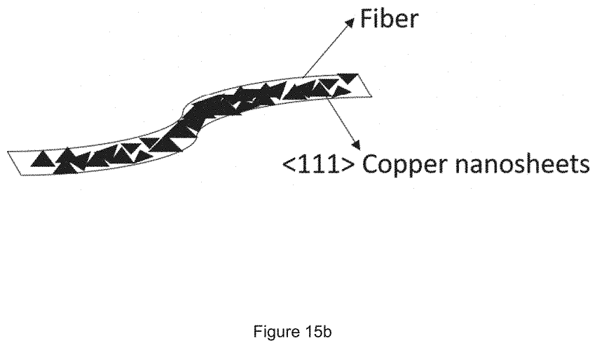

In yet a further embodiment, regular textile fibre is coated with nanosheet Cu before being spun and woven into cloths that have anti-pathogenic, especially virucidal, properties. The fibre can be plastic fibre, optical fibre, Cu fibre, cloth fibre, or any other fibre. FIG. 15a is an SEM image of synthesized Cu nanosheet. Typically, a nanosheet is a two-dimensional nanostructure with thickness in a scale ranging from 1 to 100 nm. The Cu nanosheet are all <111> orientated. To produce the <111> single crystal Cu nanosheet, the following synthesis method is used.

Firstly, Cu chloride dihydrate (CuCl₂·₂H₂O, 99+%) (0.5˜15 g/L), hexadecylamine (98%) (50˜120 g/L), and glucose (99.5+%) (10˜30 g/L) are dissolved in DI water. Subsequently, a very small amount of iodine (12, 99.8+%) is added to the same solution. The mixture solution is reacted at 50˜150° C. After the reaction, the solution is washed in chloroform and DI water several times with a centrifuge.

After the <111> single crystal Cu nanosheet has been synthesized, the <111> single crystal Cu nanosheet is then coated onto textile fibre. The fibre is coated with any suitable glue, and the synthesized Cu nanosheet is sprayed onto the fibres. In this way, as shown in FIG. 15b, the Cu nanosheet is sprinkled onto the glue-coated fibre. The resultant <111> Cu crystal coated fibre can be spun and then woven into cloth like any regular textile material. The cloth can be cut and sewn into masks, protection suits, or into suitable size and shape to be used as filters in all sorts of equipment including air-conditional filters. More preferably, the cloth may be stacked to produce a thicker filter, rather like the 3-dimensional structure described in the afore-mentioned embodiments. The fibre produced has fast virus and bacteria killing characteristics, and can be applied as broad-spectrum anti-pathogen material. In particular, <111> single crystal Cu is very stable and has exceptionally good anti-oxidation performance. The fibre can be effective even after months of usage. Therefore, the masks, protection suits, or filters have a long usage lifetime and become recyclable.

Experiment Data

The embodiments that provide a 3-dimensional structure can be used as a filter to purify the air in public buildings, used in public ventilation systems to kill airborne viruses and bacteria, especially the COVID-19 virus. The embodiments may also be adapted to into reusable face masks, air-conditioner unit filters, partition screens in a restaurant, door or window ventilation screens and so on.
1. The nanotwin-coated Cu filter materials are applied to various kinds of respiratory viruses' inactivation, including respiratory syncytial virus (RSV), rhinovirus, enterovirus, coronaviruses (including SARS and MERS CoV), adenoviruses, and parainfluenza viruses, etc;
2. The nanotwin-coated Cu filter materials are applied to various kinds of bacteria-killing, including Escherichia coli (E. coli), Staphylococcus aureus (S. aureus), Candida albicans (C. Albicans), etc.

The virucidal effects of the embodiments include killing SARS-CoV-2, H1N1, and FIPV. Different types of viruses can be inactivated within within 15˜30 min, which is an improvement over commercial Cu that requires 2 to 3 hours to inactive virus. The filter can be applied to any ventilation system, e.g. in cruises, hotels, and hospitals. It is cheap, safe, and effective compared to some commercial solutions using Ag ions to clean the air. The filter material is soft and can be made into protective suits or masks. Compared to commercial masks, the material can be recyclable and environmentally friendly. The protective suit can be used in the hospital environment to reduce nosocomial infections. The suits will be recyclable and will kill bacteria and viruses upon contact, which will also improve doctors' and nurses' safety in hospitals. The material can also be used in animal husbandry and the pet industry. For example, the material can be made into cages for cats. When a cat gets affected by FIPV and needs to be separated from other cats, our antivirus cage will be effective to protect other cats.

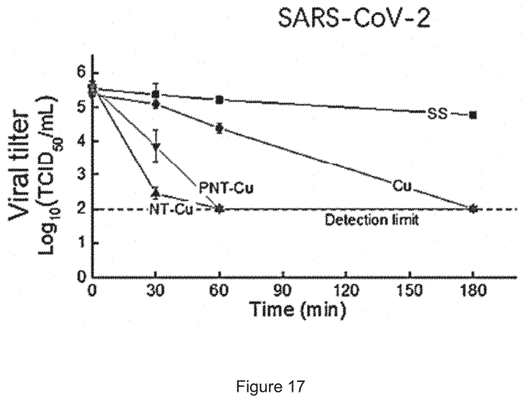

FIG. 17 is a chart plotting the inactivation effect of and on the SARS-Cov-2, where SS is stainless steel, Cu refers to just copper metal, NT-Cu refers to (111) nanotwinned Cu, and PNT-Cu refers to polished (111) nanotwinned Cu. It can be seen that the (111) nanotwin surface coating can effectively reduce the killing virus time down from 3 h using commercial Cu to 30 min.

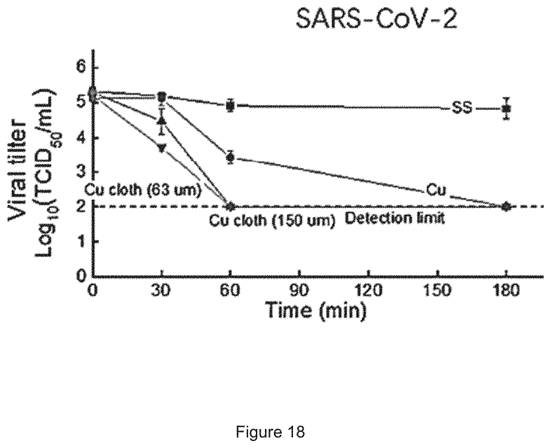

FIG. 18 shows the SARS-Cov-2 inactivation effect of Cu cloth with different pore sizes (150 μm vs. 63 μm). It can be seen that the 3D porous Cu cloth structure can effectively reduce the killing virus time from 3 h using commercial Cu to 60 min.

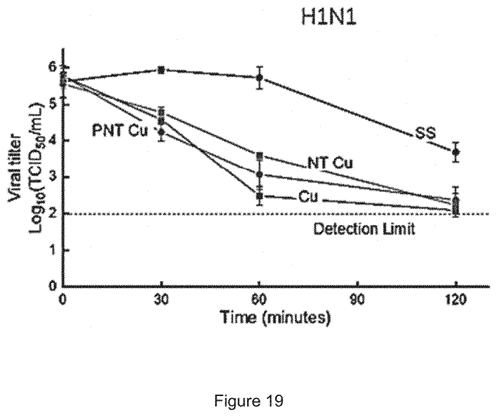

FIG. 19 shows the H1N1 inactivation effect of nanotwin Cu and polished nanotwin Cu. It can be seen that the (111) nanotwin surface coating can effectively reduce the killing virus time from 2 h using commercial Cu to 60 min.

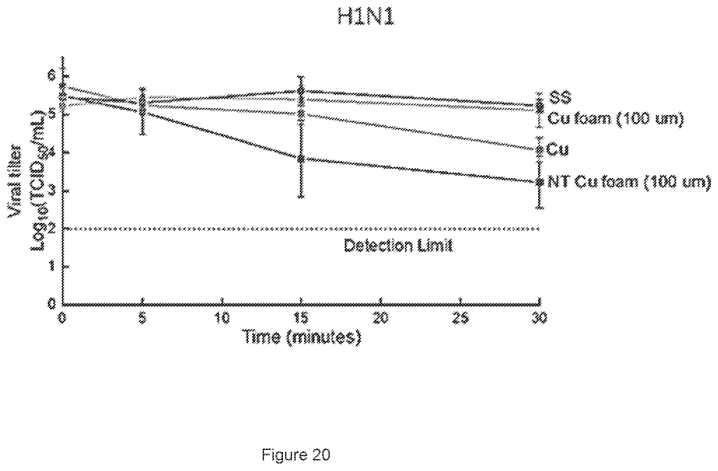

FIG. 20 shows the H1N1 inactivation effect of Cu foam and nanotwin Cu foam. It can be seen that the 3D porous Cu foam structure can effectively reduce the killing virus time to 15 min.

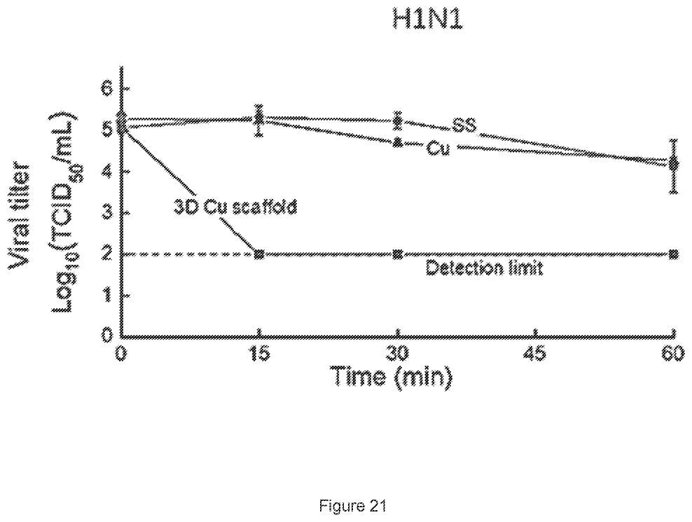

FIG. 21 shows the H1N1 inactivation effect of 3D printing Cu. It can be seen that 3D printing Cu structure can effectively reduce the killing virus time to 15 min.

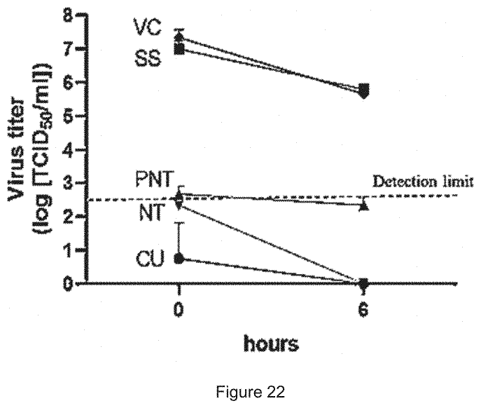

FIG. 22 shows the FIPV inactivation effect of nanotwin Cu and polished nanotwin Cu, where VC stands for virus control. It can be seen that the surface coating and the 3D porous structure are also effective for the virus of FIPV. Therefore the filter products can also be applied in animal husbandry and the pet industry.

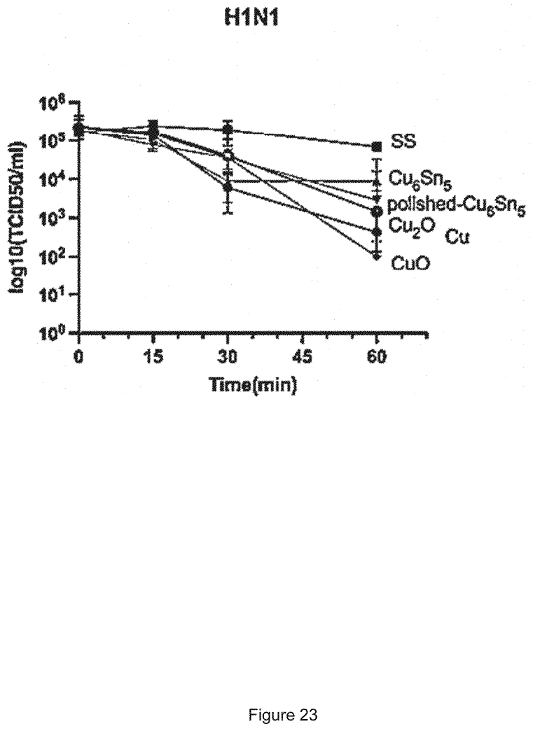

FIG. 23 shows the H1N1 inactivation effect of Cu₆Sn₅, polished Cu₆Sn₅, CuO, and Cu2O. It can be seen that the surface coating of Cu₆Sn₅, CuO, and Cu2O, has a similar antivirus effect. Showing the product surface can sustain oxidation and will have long anti-virus effects.

The following are advantages that are made possible by the embodiments.
(a) Reasonable anti-virus mechanism

Unlike other commercial filters used in the air circulation systems (fiberglass, aluminum meshes, HEPA filter), our nanotwin-coated Cu foam could trap virus particles effectively as their 3-dimensional porous structure and high specific surface area. Then, the trapped viruses will be affected by moving Cu ions and Cu atoms on the surface of Cu, and the charge transfer will happen and causing the viruses' death. Thus, the embodiments have a reasonable design mechanism from virus capture to virus killing, thus exhibiting an extremely effective virus inactivation effect.
(b) Biosafety

Cu has been used as a material for domestic devices for thousands of years and is safe for human use. Compared with other polymer-based anti-virus coatings, the pure Cu filter material showed better biosafety and was easy to get a commercial license and FDA approve (personal protection use).
(c) Labour- and cost-effectiveness

The nanotwin coated Cu foam is easy to preparation and has an obvious cost advantage. The total charge of the material is less than 0.5 USD/cm², which greatly improves and broadens the application fields.

While there has been described in the foregoing description preferred embodiments of the present invention, it will be understood by those skilled in the technology concerned that many variations or modifications in details of design, construction or operation may be made without departing from the scope of the present invention as claimed.

In particular, the electroplating or coating methods described for the different embodiments having a copper or metallic filter body can be used interchangeably, as the skilled reader would appreciate.

1. An anti-pathogen filter, comprising
a filter body having pores; wherein
the surfaces of the filter body are coated with any one of
(a) (111) nanotwin Cu;
(b) Cu₆Sn₅ scallop; or
(c) (111) Cu nanosheet.

2. An anti-pathogen filter as claimed in claim 1, wherein
the surfaces of the filter body are coated with (111) nanotwin Cu or Cu₆Sn₅ scallop; and
the filter body is a Cu structure.

3. An anti-pathogen filter as claimed in claim 2, wherein
the filter body is a Cu foam.

4. An anti-pathogen filter as claimed in claim 2, wherein
the filter body is a cloth, the cloths being woven of fibre coated with Cu threads.

5. An anti-pathogen filter as claimed in claim 2, wherein
the filter body is 3D printer Cu structure.

6. An anti-pathogen filter as claimed in claim 2, wherein
the filter body is connected to a supply an electrical current to heat the filter such that the filter is at a temperature of 50 degrees C. to 200 degrees C.

7. An anti-pathogen filter as claimed in claim 1, wherein
the filter body comprises cloth woven from fibre; and
the surface of the fibre is adhered with (111) Cu nanosheet.

8. A method of making an anti-pathogen filter comprising the step of:
providing a filter body;
coating the filter body with
(a) (111) nanotwin Cu;
(b) Cu₆Sn₅ scallop; or
(c) (111) Cu nanosheet.

9. A method of making an anti-pathogen filter as claimed in claim 8, where the filter body is a Cu filter body, and the Cu filter body is coated with (111) nanotwin Cu;
the method comprising the step of:
providing the Cu filter body;
electroplating the Cu filter body to coating the surface of the Cu filter body with nanotwin microstructure on the surface; wherein
the electroplating step includes applying high current density under the following electroplating parameters.
Current density: 2 A/dm² (ampere per square decimeter, ASD) to 14 A/dm².
Stirring speed: 500-1200 rpm (magnet)|

Cathode: the Cu filter body;
Anode: pure Cu;
distance between cathode and anode: 1-8 cm.
Electroplating solution: high-purity of CuSO₄ solution composed of 0.8 M Cu cations, KCl composed of 80 ppm chloride, 4000 ppm of surfactant, and 50 g/L-110 g/L of H₂SO₄.

10. A method of making an anti-pathogen filter as claimed in claim 8, where the filter body is a Cu filter body, and the Cu filter body is coated with Cu₆Sn₅ scallop;
the method comprising the steps of:
immersing the Cu filter body into Sn liquid for a few seconds.
removing the Cu filter body from the Sn liquid; and
applying an etchant at 80 degrees Celsius to etch unreacted Sn on the surface of the Cu filter body, the etchant being 1 part nitric acid, 1 part acetic acid, and 4 parts glycerol.

11. A method of making an anti-pathogen filter as claimed in claim 9, where the filter body comprises cloth woven from fibre; and
the surface of the fibre is adhered with (111) Cu nanosheet.
the method comprising the steps of:
dissolving into deionised water Cu chloride dihydrate, hexadecylamine and glucose to make a solution;
adding iodine (12, 99.8+%) into the solution;
mixing the solution at a temperature of 50˜150° C. to let the content in the solution react;
extracting precipitated <111> single crystals of Cu of the reaction using chloroform;
washing the precipitate with chloroform;
washing the precipitate with water;
providing fibre coated with adhesive;
coating the adhesive with the <111> single crystals of Cu;
spinning the fibre coated with <111> single crystals of Cu into threads and weaving the threads to produce the cloth.

12. A method of making an anti-pathogen filter as claimed in claim 11, wherein the solution comprises:
Cu chloride dihydrate (CuCl₂·₂H₂O, 99+%) at 0.5 to 15 g/L;
hexadecylamine (98%) at 50 to 120 g/L; and
glucose (99.5+%) at 10˜30 g/L.

13. A method of making an anti-pathogen filter as claimed in claim 12, wherein the method comprises the further steps of:
applying an adhesive to coat fibres;
mixing the adhesive-coated fibres with the <111> single crystals of Cu;
spinning the fibres of the anti-pathogen material into threads.

14. A method of making an anti-pathogen filter as claimed in claim 8, where the filter body is a Cu filter body, and the Cu filter body is coated with (111) nanotwin Cu or Cu₆Sn₅ scallop;
the method comprising earlier steps of:
providing pieces of cloths woven of Cu threads;
annealing each piece of cloth under a slight compression to provide the cloth with a flat surface.
stacking the pieces of the cloth to form a 3-dimensional structure; wherein
the holes of every adjacent layer of metal cloth is eccentrically displaced at 45 degrees; and
the distance of displacement is the width of the metal wires used to weave the cloth.
